(19) United States
(12) Patent Application Publication
(10) Pub. No.: US 2026/0350691 A1
(43) Pub. Date: Nov. 5, 2026

(54) LIST PROCESSING METHOD AND APPARATUS, DEVICE, AND STORAGE MEDIUM

(71) Applicant: Beijing Youzhuju Network Technology Co., Ltd., Beijing (CN)

(72) Inventors: Yuanheng LI, Beijing (CN); Dilu XU, Beijing (CN)

(21) Appl. No.: 19/485,908

(22) PCT Filed: Jun. 6, 2024
(86) PCT No.: PCT/CN2024/097712

§ 371 Date: Nov. 19, 2025

(30) Foreign Application Priority Data
Jun. 28, 2023 (CN) 202310782892.4

(51) Int. Cl. G06Q 30/0601; G06F 3/0482; G06F 3/0483; G06F 3/0484

(52) U.S. Cl. CPC G06Q 30/0643; G06F 3/0482; G06F 3/0483; G06F 3/0484; G06Q 30/0631

(57) ABSTRACT

The present disclosure provides a list processing method, apparatus, and device, and a storage medium. The method includes: first displaying a first list on a first page, wherein a plurality of listed objects having a sequential relationship are presented on the first list, and the listed object is used for identifying an object set obtained by aggregation based on aggregation information; and then when a trigger operation for a target listed object on the first list has been received, displaying, on a second page, an object in an object set identified by the target listed object.

### CROSS-REFERENCE TO RELATED APPLICATION(S)

This application claims priority to Chinese Patent Application No. 202310782892.4, entitled “LIST PROCESSING METHOD, AND APPARATUS, DEVICE, AND STORAGE MEDIUM” filed on Jun. 28, 2023, which is incorporated by reference in its entirety.

### FIELD

The present disclosure relates to the field of data processing, and in particular, to a list processing method, apparatus, and device, and a storage medium.

### BACKGROUND

In the field of e-commerce, a list function is an indispensable shelf shopping guide ability, and a user may pay attention to information such as the ranking of an object. A current list function is usually based on an object-dimensional list. That is, each listed object on the list only corresponds to a specific object of a store. A method for displaying the above list function is relatively simple and cannot meet a need of a user for the list function.

Therefore, how to enrich a method for displaying a list and meet a need of a user for a list function is a technical problem that urgently needs to be solved.

### SUMMARY

In order to solve the above technical problems, embodiments of the present disclosure provide a list processing method.

In a first aspect, the present disclosure provides a list processing method, including:
displaying a first list on a first page, wherein a plurality of listed objects having a sequential relationship are presented on the first list, and the listed object is used for identifying an object set obtained by aggregation based on aggregation information; and
in response to a trigger operation for a target listed object on the first list, presenting, on a second page, an object in an object set identified by the target listed object.

In an optional implementation, before the displaying a first list on a first page, the method further includes:
determining, in response to a list presenting trigger operation performed on a third page corresponding to a first object, a list to which the first object belongs as the first list, and obtaining the listed objects in the first list.

In an optional implementation, before the determining, in response to a list presenting trigger operation performed on a third page corresponding to a first object, a list to which the first object belongs as the first list, the method further includes:
displaying the third page in response to a display request for the third page corresponding to the first object, and determining whether the first object belongs to at least one list; and
if it is determined that the first object belongs to at least one list, displaying, on the third page, ranking information of the first object on a target list among the at least one list.

Correspondingly, the determining, in response to a list presenting trigger operation performed on a third page corresponding to a first object, a list to which the first object belongs as the first list includes:
determining, in response to a trigger operation for the ranking information, the target list corresponding to the ranking information as the first list.

In an optional implementation, a plurality of categories are configured on the first page; the plurality of categories have a multi-level category structure relationship; the plurality of categories respectively have corresponding lists; listed objects of the lists belong to the categories corresponding to the lists; and the displaying a first list on a first page includes:
displaying, in response to a trigger operation for a target category among the plurality of categories, a list corresponding to the target category on the first page.

In an optional implementation, the displaying, in response to a trigger operation for a target category among the plurality of categories, a list corresponding to the target category on the first page includes:
in response to the trigger operation for the target category among the plurality of categories, sending, to a first target service end, a list display request that carries a target category identification corresponding to the target category, wherein the first target service end is configured to obtain, from a preset cache, a plurality of standard product unit (SPU) identifications having a sequential relationship and corresponding to the target category identification, and the SPU identifications are used for identifying the listed objects; and
displaying, on the first page, the listed objects respectively corresponding to the SPU identifications having the sequential relationship.

In an optional implementation, the listed objects have SPU identifications; the SPU identifications are used for identifying the listed objects; and in response to a trigger operation for a target listed object on the first list, displaying, on a second page, an object in an object set identified by the target listed object includes:
in response to the trigger operation for the target listed object on the first list, sending an SPU identification corresponding to the target listed object and a search keyword to a second target service end, wherein the second target service end is configured to: obtain an object set corresponding to the SPU identification from a preset cache and determine a search result object based on the search keyword; and
displaying the object in the object set on the second page.

Correspondingly, the method further includes:
displaying the search result object on the second page.

In an optional implementation, in response to the display request, if it is determined that the first object belongs to at least one list, the displaying, on the third page, ranking information of the first object on a target list among the at least one list includes:
in response to the display request, sending a page display request for the third page to a third target service end, wherein the third target service end is configured to: determine, in a preset cache, whether the first object belongs to any list, and when it is determined that the first object belongs to at least one list, obtain the ranking information of the first object on the target list among the at least one list; and
displaying, on the third page, the ranking information of the first object on the target list among the at least one list.

In an optional implementation, the determining, in response to a list presenting trigger operation performed on a third page corresponding to a first object, a list to which the first object belongs as the first list, and obtaining the listed objects in the first list includes:
in response to the list presenting trigger operation performed on the third page corresponding to the first object, sending, to a fourth target service end, a list presenting request that carries an object identification of the first object, wherein the fourth target service end is configured to: determine, from a preset cache, a target list identification corresponding to the object identification of the first object, and obtain a plurality of SPU identifications having a sequential relationship and corresponding to the target list identification; the SPU identifications are used for identifying the listed objects; and
receiving the plurality of SPU identifications having the sequential relationship and corresponding to the object identification of the first object.

Correspondingly, the displaying a first list on a first page includes:
displaying, on the first page, the listed objects respectively identified by the SPU identifications having the sequential relationship.

In an optional implementation, the preset cache is configured to store a list generated based on a preset cycle; and the list includes the SPU identifications having the sequential relationship, a correspondence relationship between a list identification of the list and the category identifications, and a correspondence relationship between the SPU identifications and the object sets.

In a second aspect, the present disclosure provides a list processing apparatus, including:
a first display module, configured to display a first list on a first page, wherein a plurality of listed objects having a sequential relationship are presented on the first list, and the listed object is used for identifying an object set obtained by aggregation based on aggregation information; and
a presentation module, configured to: in response to a trigger operation for a target listed object on the first list, present, on a second page, an object in an object set identified by the target listed object.

In a third aspect, the present disclosure provides a computer-readable storage medium, having an instruction stored therein, wherein the instruction, when executed on a terminal device, causes the terminal device to implement the above method.

In a fourth aspect, the present disclosure provides a list processing device, including a memory, a processor, and a computer program stored on the memory and executable on the processor, wherein the processor, when executing the computer program, implements the above method.

In a fifth aspect, the present disclosure provides a computer program product, wherein the computer program product includes a computer program/instruction, and the computer program/instruction, when executed by a processor, implements the above method.

Compared with the existing technology, the technical solutions provided by the embodiments of the present disclosure at least have the following advantages:

The embodiments of the present disclosure provide a list processing method. The method includes: first displaying a first list on a first page, wherein a plurality of listed objects having a sequential relationship are presented on the first list, and the listed object is used for identifying an object set obtained by aggregation based on aggregation information; and then when a trigger operation for a target listed object on the first list has been received, presenting, on a second page, an object in an object set identified by the target listed object.

### BRIEF DESCRIPTION OF THE DRAWINGS

The drawings here are incorporated into and form part of the specification, showing the embodiments that comply with the present disclosure, and are used together with the specification to explain the principles of the present disclosure.

In order to describe the technical solutions in the embodiments of the present disclosure or in the related art more clearly, the following briefly introduces the accompanying drawings for describing the embodiments or the related art. Apparently, a person of ordinary skill in the art may still derive other drawings from the accompanying drawings without creative effort.

FIG. 1 is a flowchart of a list processing method according to an embodiment of the present disclosure;

FIG. 2 is a schematic diagram of a first page according to an embodiment of the present disclosure;

FIG. 3 is a schematic diagram of a second page according to an embodiment of the present disclosure;

FIG. 4 is a schematic diagram of another first page according to an embodiment of the present disclosure;

FIG. 5 is a flowchart of another list processing method according to an embodiment of the present disclosure;

FIG. 6 is a diagram of a circulation situation according to an embodiment of the present disclosure;

FIG. 7 is a schematic diagram of a list processing system according to an embodiment of the present disclosure;

FIG. 8 is a schematic structural diagram of a list processing apparatus according to an embodiment of the present disclosure; and

FIG. 9 is a schematic structural diagram of a list processing device according to an embodiment of the present disclosure.

### DETAILED DESCRIPTION OF EMBODIMENTS

In order to better understand the above objectives, features, and advantages of the present disclosure, the following will further describe the solutions of the present disclosure. It should be noted that the embodiments of the present disclosure and features in the embodiments may be mutually combined without conflicts.

Many specific details have been elaborated in the following description to facilitate a full understanding of the present disclosure, but the present disclosure can also be implemented in other ways different from those described here. Obviously, the embodiments in the specification are only part of the embodiments of the present disclosure, rather than all the embodiments.

In the field of e-commerce, a list function is an indispensable shelf shopping guide ability, and a user may pay attention to information such as the ranking of an object. A current list function is usually based on an object-dimensional list. That is, each listed object on the list only corresponds to a specific object of a store. The above list function cannot meet a need of a user for the list function.

To this end, the embodiments of the present disclosure provide a list processing method. The method includes: firstly, displaying a first list on a first page, wherein a plurality of listed objects having a sequential relationship are presented on the first list, and the listed object is used for identifying an object set obtained by aggregation based on aggregation information; and then when a trigger operation for a target listed object on the first list has been received, presenting, on a second page, an object in an object set identified by the target listed object. As can be seen, the embodiments of the present disclosure can display listed objects on a list based on an object set obtained by aggregation of aggregation information, thereby enriching a method for displaying a list and meeting a need of a user for a list function.

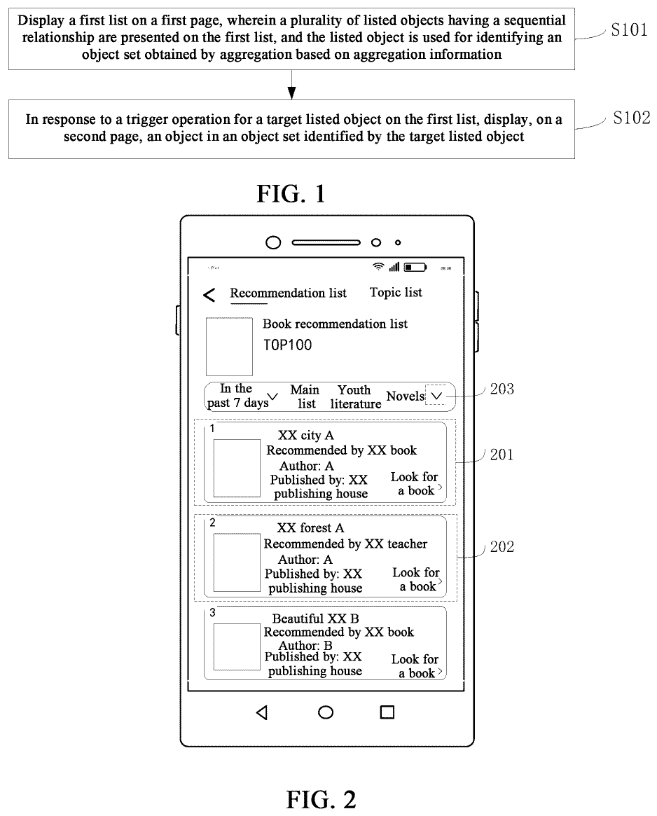

Based on this, an embodiment of the present disclosure provides a list processing method. FIG. 1 shows a flowchart of a list processing method according to an embodiment of the present disclosure. The method specifically includes:
S101: A first list on a first page is displayed.

A plurality of listed objects having a sequential relationship are presented on the first list, and the listed object is used for identifying an object set obtained by aggregation based on aggregation information.

The list processing method provided in this embodiment of the present disclosure can be applied to a client. For example, the client may include a client deployed on a smart phone, a client deployed on a tablet computer, or the like.

In this embodiment of the present disclosure, the first page may include a plurality of lists. The first list is any of the plurality of lists. The first page is specifically used for displaying the first list. For example, assuming that the first page is an aggregation display page of a book ranking list, the first list may include a book recommendation list, a book topic list, and the like.

In this embodiment of the present disclosure, a plurality of listed objects having a sequential relationship are presented on the first list. For example, assuming that the first list is a book collection list, the plurality of listed objects presented on the first list may include book “XX City” written by author A, book “XX Forest” written by author A, and the like.

In this embodiment of the present disclosure, the listed objects may be used for identifying an object set obtained by aggregation based on aggregation information. The aggregation information is used for aggregating a plurality of objects with the same attribute values or characteristics into an object set. For example, a plurality of books “XX City” written by author A and sold in different stores can be aggregated into a book set. The book set can be identified by the above listed objects.

In this embodiment of the present disclosure, the sequential relationship between the plurality of listed objects may be specifically determined based on statistical data of a dimension corresponding to the object set identified by the listed objects. For example, the sequential relationship between the plurality of listed objects may be determined based on statistical data of a dimension such as a recommendation quantity, a topic quantity, a favorites quantity, or a view quantity of the book set identified by the listed objects. For example, listed objects corresponding to top three book sets are presented on the first list in an order of recommendation quantities from large to small.

FIG. 2 is a schematic diagram of a first page according to an embodiment of the present disclosure. The first page may be an aggregation display page for a book list. A first list displayed on the first page is, for example, a book recommendation list. Specifically, the book recommendation list may present a plurality of listed objects having a sequential relationship, such as a listed object 201 named “XX City” and written by author A and a listed object 202 named “XX Forest” and written by author A. Objects in an object set identified by the listed object 201 may include a plurality of book objects that are named “XX City”, written by author A, and sold in different stores.

In an optional implementation, in the process of presenting the plurality of listed objects on the first list, for each listed object, attribute information of the listed object and the aggregation information of the object set identified by the listed object may be presented respectively, so that in a process of browsing the listed object, a user may determine, based on the aggregation information and the attribute information that are presented on the listed object, whether to display an object in the object set identified by the listed object. The aggregation information may include a name, an author, and the like, and the attribute information may include a book cover, recommendation words, a publishing house, and the like.

As shown in FIG. 2, the aggregation information presented on the listed object 201 may include a book name, an author name, and the like. The attribute information presented on the listed object 201 may include a book cover, recommendation words, a publishing house, and a jump link such as “Find a book”.

In this embodiment of the present disclosure, since the listed objects can be used for identifying the object sets obtained by aggregation based on the aggregation information, in the process of displaying the plurality of listed objects having the sequential relationship on the first list, a user may determine, based on each listed object, whether to display an object in the object set identified by the listed object.

In an optional implementation, in the process of displaying the plurality of listed objects having the sequential relationship on the first list, ranks of the listed objects in the first list may be respectively displayed at preset positions on the listed objects. As shown in FIG. 2, word “1” may be displayed at an upper left corner of the listed object 201 to indicate that the listed object 201 is in the first place in the first list.
S102: In response to a trigger operation for a target listed object on the first list, an object in an object set identified by the target listed object is presented on a second page.

In this embodiment of the present disclosure, the target listed object may be any of the plurality of listed objects presented on the first list. The trigger operation for the target listed object may include a tapping operation for the target listed object. This embodiment of the present disclosure does not limit this.

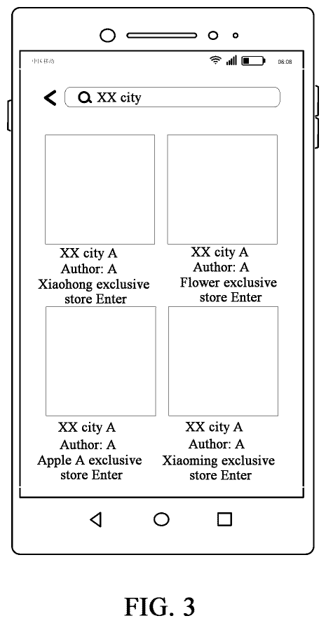

In this embodiment of the present disclosure, the second page is used for displaying the objects in the object set identified by the target listed object. The second page may include a search result page that displays the objects in the object set. For example, when a trigger operation for a listed object “XX city, A” on a book recommendation list, the listed object “XX city, A” is determined as the target listed object, and objects in an object set identified by the target listed object “XX city, A” are displayed on the second page shown in FIG. 3. FIG. 3 is a schematic diagram of a second page according to an embodiment of the present disclosure. FIG. 3 shows a plurality of book objects that are sold in different stores, named XX City, and written by author A.

In an optional implementation, the plurality of listed objects in the first list respectively have SPU identifications. It can be understood that each listed object corresponds to an SPU identification, and the SUP identification may be used for identifying the listed object.

SPU stands for standard product unit, which is the smallest unit of product information aggregation. It is a set of reusable and easily retrievable standard information that describes characteristics of a product. Generally, products with the same attribute values and the same characteristics may be referred to as an SPU, namely, a listed object.

In an optional implementation, when a trigger operation for the target listed object on the first list has been received, an SPU identification and a search keyword that correspond to the target listed object may also be sent to a second target service end. The second target service end determines the object in the object set identified by the target listed object presented on the second page.

It should be noted that the second target service end in this embodiment of the present disclosure, as well as subsequently mentioned first, third, and fourth target service ends, may be the same service end or different service ends.

In this embodiment of the present disclosure, since a correspondence relationship between the SPU identifications and the object sets, and a correspondence relationship between the search keywords and search result objects are prestored in a preset cache, when receiving the SPU identification and the search keyword that correspond to the target listed object, the second target service end may obtain, from the preset cache, the object set corresponding to the SPU identification and the search result object determined based on the search keyword.

In an optional implementation, the second target service end may send the obtained object set and search result object to the client when obtaining the object set corresponding to the SPU identification and the search result object determined based on the search keyword.

In this embodiment of the present disclosure, when the SPU identification and the search keyword that correspond to the target listed object have been received, the object in the object set and the search result object are displayed on the second page.

In an optional implementation, since a user triggers displaying of the object in the object set and the search result object on the second page through the trigger operation for the target listed object, in order to make the user have an expectation on content displayed on the second page, a display priority of the object in the object set corresponding to the SPU identification may be set in front of that of the search result object. That is, the object in the object set is presented first, and then the search result object is presented.

In the list processing method according to this embodiment of the present disclosure, the method includes: first displaying a first list on a first page, wherein a plurality of listed objects having a sequential relationship are presented on the first list, and the listed object is used for identifying an object set obtained by aggregation based on aggregation information; and then when a trigger operation for a target listed object on the first list has been received, presenting, on a second page, an object in an object set identified by the target listed object. As can be seen, the embodiments of the present disclosure may display listed objects on a list based on an object set obtained by aggregation of aggregation information, thereby enriching a method for displaying a list and meeting a need of a user for a list function.

In practical applications, in order to further enrich the method for displaying a list and meet a need of a user for a list classification function, a plurality of categories may be configured on the first page, and the plurality of categories have a multi-level category structure relationship. The plurality of categories have corresponding lists. By setting the plurality of categories having the multi-level category structure relationship, the lists corresponding to the categories have classification functions, which facilitates browsing and viewing of a user.

In this embodiment of the present disclosure, category is a way of classifying products. The plurality of categories have the multi-level category structure relationship. The multi-level category structure relationship between the plurality of categories may be determined by their belonging relationship. For example, assuming that a second-level category is a ranking list of all “novels”, and a third-level category may be a ranking list of novels for a theme, such as a ranking list of fantasy novels and a ranking list of martial arts novels.

As shown in FIG. 2, the category currently displayed on the first page is a first-level category. A control 203 of “expand all” is set in a right hand side region of the first-level category. All second-level categories are displayed on the first page by tapping the control 203.

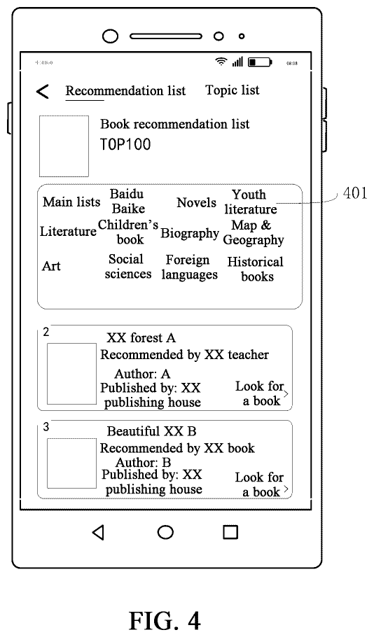

FIG. 4 is a schematic diagram of another first page according to an embodiment of the present disclosure. Categories displayed on a first page shown in FIG. 4 are second-level categories. If any category among the second-level categories is tapped, third-level categories included in the second-level category may be expanded. For example, the third-level categories may be all categories included in a second-level category “Youth literature” 401.

In this embodiment of the present disclosure, the plurality of categories have corresponding lists. Listed objects on the lists belong to the categories corresponding to the lists. For example, a list corresponding to the second-level category “Youth literature” may be a ranking list of “Youth literature” books. Specifically, a listed object in the ranking list of “Youth literature” books may be a plurality of novels XX Forest that are sold in different stores and the theme “Youth literature”.

In this embodiment of the present disclosure, in the process of displaying the plurality of categories on the first page, since the plurality of categories have their corresponding lists, when a trigger operation for a target category among the plurality of categories has been received, a list corresponding to the target category is displayed on the first page.

In this embodiment of the present disclosure, the target category may be any of the plurality of categories. The trigger operation for the target category may include a tapping operation performed on the target category to trigger displaying of the list corresponding to the target category on the first page.

As shown in FIG. 4, the plurality of categories such as “Youth literature” and “Novels” are displayed on the first page. When a trigger operation for the category “Novels” has been received, a list corresponding to the category “Novels” is displayed on the first page, namely a ranking list of a plurality of listed objects with a novel theme.

As can be seen, this embodiment of the present disclosure may achieve an effect of updating and displaying lists on the first page based on the correspondence relationship between category identifications and the lists, thereby further enriching the method for displaying a list. In addition, categories mean a classification function, so this embodiment of the present disclosure may achieve the classification function on the lists displayed on the first page by setting a plurality of categories, thereby satisfying a need of a user for a list classification function.

In an optional implementation, when a trigger operation for a target category among the plurality of categories has been received, a list display request that carries a target category identification corresponding to the target category may also be sent to the first target service end, and the first target service end determines a list corresponding to the target category displayed on the first page.

The list display request carries the target category identification corresponding to the target category, and the list display request is specifically used for requesting the first target service end to return the list corresponding to the target category.

In this embodiment of the present disclosure, the preset cache may be configured to store a list generated based on a preset cycle. The list includes the SPU identifications having the sequential relationship, a correspondence relationship between a list identification of the list and the category identifications, and a correspondence relationship between the SPU identifications and the object sets.

In an optional implementation, since the list includes the correspondence relationship between the category identifications and the list identification and the correspondence relationship between the list identification and the SPU identifications, when receiving the list display request, the first target server may obtain a list identification corresponding to the target category identification from the preset cache based on the target category identification carried in the list display request. Then, the first target server obtains, based on the correspondence relationship between the list identification and the SPU identifications, a plurality of SPU identifications having a sequential relationship and corresponding to the list identification from the preset cache. Since the SPU identifications can be used for identifying listed objects in the list, the first target server may also obtain a plurality of listed objects in the list from the preset cache based on the SPU identifications, and send the plurality of obtained listed objects to the client.

In this embodiment of the present disclosure, after receiving the listed objects respectively corresponding to the plurality of SPU identifications having the sequential relationship, the listed object is displayed on the first page.

In this embodiment of the present disclosure, the preset cache pool further stores a correspondence relationship between the SPU identifications and the object sets identified by the listed objects. Therefore, the first target server may also determine a plurality of object sets in the list based on the SPU identifications.

In an optional implementation, the lists stored in the preset cache pool may be generated based on a preset cycle, specifically including generating a list every fixed interval, such as every 1 second or every 0.5 seconds. In practical applications, the preset cycle may be determined based on actual needs. This embodiment of the present disclosure does not limit it.

In an optional implementation, a book list is taken as an example. Every fixed interval, the first target server firstly determines a plurality of SPU identifications corresponding to a target list based on the correspondence relationship between the list identifications and the SPU identifications, then determines object sets respectively corresponding to the SPU identifications based on the correspondence relationship between the SPU identifications and the object sets, and counts data of the object sets in the same dimension. Next, based on the statistical data in this dimension, a display order of the object sets, corresponding to the SPU identifications, in the target list is determined, that is, a presentation order of a plurality of listed objects in the target list.

For example, assuming that object sets corresponding to list W are A, B, and C. At the 1st second, favorites quantities of the object sets A, B, and C are counted. A favorites quantity of the object set A at the 1st second is 10; a favorites quantity of the object set B at the 1st second is 13; and a favorites quantity of the object set C at the 1-st second is 2. According to an order of the favorites quantities from large to small, a sequential relationship between the object sets corresponding to list W is B, A, C, namely, a sequential relationship between listed objects in list W. Then, the sequential relationship is stored into the preset cache.

Every five seconds, that is, at the 6th second, favorites quantities of the object sets A, B, and C are recounted. Assuming that a favorites quantity of the object set A at this time is 1, a favorites quantity of the object set B at this time is 13, and a favorites quantity of the object set C at this time is 16. Based on the favorites quantities from large to small, a redetermined sequential relationship is C, B, A, and the sequential relationship between the plurality of listed objects in list W is updated based on the redetermined sequential relationship.

As can be seen, this embodiment of the present disclosure may count data in a dimension corresponding to a plurality of listed objects in a list, determine an arrangement order of the listed objects in the list based on the statistical data, and store the arrangement order of SPU identifications used for identifying the listed objects into a preset cache, thereby implementing the function of generating a list based on the preset cycle.

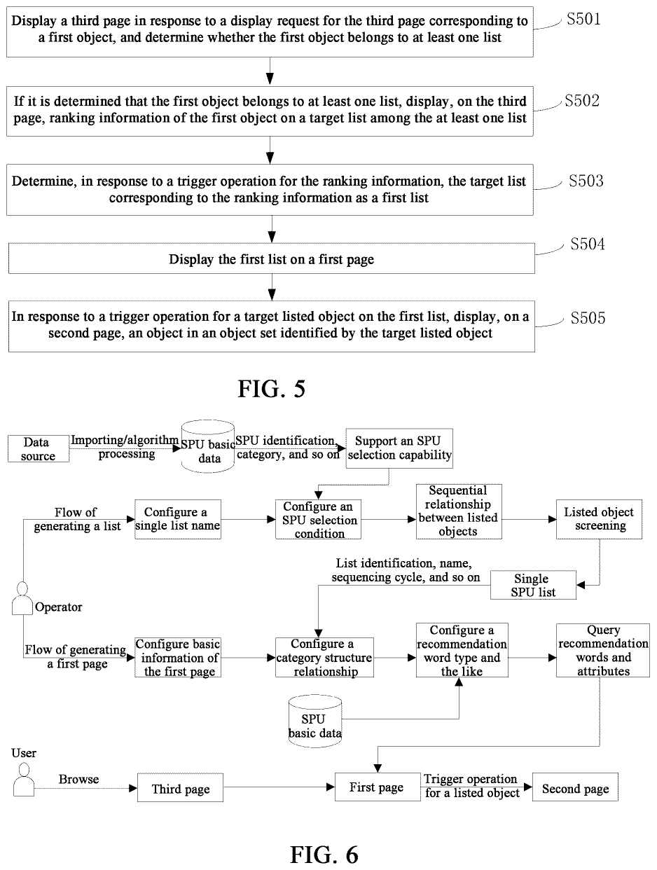

Based on the above method embodiment, an embodiment of the present disclosure further provides a flowchart of a list processing method. FIG. 5 shows a flowchart of a list processing method according to an embodiment of the present disclosure. The method specifically includes:
S501: A third page is displayed in response to a display request for the third page corresponding to a first object, and whether the first object belongs to at least one list is determined.

In this embodiment of the present disclosure, the first object may include objects such as a book, a mobile phone, and a computer. The third page corresponding to the first object may include a page that displays the first object or description information of the first object, such as a detail display page for a particular book, a livestreaming page for a mobile phone, and a short video playback page of a computer that is included in an image frame.

In practical applications, in a process that a user browses a search result page for books on a particular theme, through a trigger operation for a book, such as a tapping operation, the user can trigger a display request for a detail display page of the book. The detail display page of the book is the third page of the first object.

In this embodiment of the present disclosure, when the display request for the third page corresponding to the first object has been received, the third page is displayed, and whether the first object belongs to at least one list is determined, so that ranking information of the first object on a target list among the at least one list may be subsequently displayed on the third page.
S502: If it is determined that the first object belongs to at least one list, ranking information of the first object on a target list among the at least one list is displayed on the third page.

In an optional implementation, when a display request for the third page corresponding to the first object has been received, a page display request for the third page may be sent to a third target service end, and the third target service end determines whether the first object belongs to at least one list.

In this embodiment of the present disclosure, when receiving the page display request for the third page, the third target service end determines, from a preset cache, whether the first object belongs to any list, and when it is determined that the first object belongs to at least one ranking list, obtains the ranking information of the first object on the target list among the at least one list.

In this embodiment of the present disclosure, the target list may be any of the at least one list, or may be a top-ranked list among the at least one list. For example, when it is determined that the first object belongs to two different lists, a top-ranked list in the two lists may be determined as the target list, and the ranking information on the target list may be obtained. The ranking information may include a category to which the target list belongs and a rank of the target list in the category. For example, the ranking information on the target list may be the target list being selected to be in the third place on the youth literature ranking list.

In an optional implementation, the preset cache may pre-store a corresponding relationship between object identifications and list identifications. When receiving the page display request for the third page, the third target service end firstly obtains an object identification of the first object from the page display request; then queries whether the preset cache stores a list identification corresponding to the object identification of the first object; if it is determined that the preset cache stores at least one list identification corresponding to the object identification, determines the target list from a list corresponding to the at least one list identification; and sends the ranking information on the target list to the client.

In this embodiment of the present disclosure, when receiving the ranking information, sent by the third target service end, on the target list, the ranking information of the first object on the target list is displayed on the third page, so that whether to present the target list may be subsequently determined based on the ranking information on the target list.
S503: In response to a trigger operation for the ranking information, the target list corresponding to the ranking information as a first list is determined.

In this embodiment of the present disclosure, the third page corresponding to the first object may display ranking information for a list to which the first object belongs, such as words “Selected to be in the third place on the youth literature ranking list”. Therefore, a list presenting trigger operation performed on the third page corresponding to the first object may include a trigger operation for the ranking operation to trigger determining the target list corresponding to the ranking information as the first list.

In an optional implementation, when receiving a list presenting trigger operation performed on the third page corresponding to the first object, a list presenting request that carries an object identification of the first object may be sent to a fourth target service end, and the fourth target service end may determine a plurality of SPU identifications having a sequential relationship and corresponding to the object identification of the first object.

In this embodiment of the present disclosure, when receiving the list presenting request that carries the object identification of the first object, the fourth target service end determines a target list identification corresponding to the object identification of the first object from the preset cache, and obtains the plurality of SPU identifications having the sequential relationship and corresponding to the target list identification.

In this embodiment of the present disclosure, the preset cache stores a correspondence relationship between object identifications and list identifications. The fourth target service end may query the target list identification corresponding to the object identification of the first object from the preset cache based on the above correspondence relationship. In addition, the preset cache further stores a correspondence relationship between list identifications and SPU identifications. Therefore, when determining the target list identification corresponding to the object identification of the first object from the preset cache, the fourth target service end may also obtain the plurality of SPU identifications having the sequential relationship and corresponding to the target list identification.

In this embodiment of the present disclosure, after obtaining the plurality of SPU identifications having the sequential relationship and corresponding to the target list identification and obtaining the plurality of SPU identifications having the sequential relationship and corresponding to the target list identification, the fourth target service end may also send the plurality of SPU identifications having the sequential relationships and corresponding to the object identification of the first object to the client.
S504: The first list on a first page is displayed.

In an optional implementation, since the SPU identifications may be used for identifying listed objects, when the plurality of SPU identifications having the sequential relationship and corresponding to the object identification of the first object have been received, the listed objects respectively identified by the plurality of SPU identifications having the sequential relationship may be displayed on the first page.
S505: In response to a trigger operation for a target listed object on the first list, an object in an object set identified by the target listed object is presented on a second page.

In this embodiment of the present disclosure, the target listed object may be any of the plurality of listed objects presented on the first list. The trigger operation for the target listed object may include a tapping operation for the target listed object.

In this embodiment of the present disclosure, the second page is used for presenting the object in the object set identified by the target listed object. For example, the second page may be a search result page that displays the object in the object set.

As can be seen, in the process of presenting the first object on the third page in this embodiment of the present disclosure, a function of obtaining a plurality of listed objects in the first list and displaying the plurality of listed objects in the first list on the first page may be also triggered through a list presenting trigger operation performed on the third page corresponding to the first object, thereby further enriching a method for presenting a list and enhancing a user experience.

Based on the above method embodiment, the present disclosure further provides a diagram of a circulation situation of list data. Specifically, a book list is taken as an example to describe a circulation situation of data (i.e. data corresponding to books) corresponding to objects in object sets identified by listed objects in the entire book list. FIG. 6 is a diagram of a circulation situation of list data according to an embodiment of the present disclosure.

Firstly, SPU basic data is obtained. Specifically, algorithm processing is performed on an external data source to obtain names, authors, and other data of the book objects, which are stored into a database. Alternatively, a correspondence relationship between SPU identifications and object sets is generated through algorithm processing on an internal data source, and is stored into a database, to obtain SPU basic data. The SPU basic data may include names, authors, recommendation words, the SPU identifications, the correspondence relationship between the SPU identifications and the object sets, categories, and the like of the book objects.

In a process of generating lists (by an operator), firstly, list names of the lists are configured, such as a Youth literature list and a children's book list, and a selection condition is configured, for example, a book object belongs to the Youth literature list. Then, a sequential relationship between a plurality of listed objects on a list is determined based on statistical data in a dimension corresponding to a book object set. For example, the sequential relationship between the plurality of listed objects is determined based on statistical data of a dimension such as a recommendation quantity, a topic quantity, a favorites quantity, and a viewer quantity of book sets identified by the listed objects. Finally, the plurality of listed objects are filtered (i.e., list objects displayed on the lists are determined). For example, listed objects corresponding to the top three book sets are presented on a list according to the recommendation quantities from large to small, thereby generating a single book list.

In a process of generating a first page (by an operator), first, basic information on the first page is configured, such as a name of a list currently displayed on the first page and a quantity of listed objects, and a plurality of categories, a multi-level category structure relationship between the plurality of categories, and a correspondence relationship between the categories and list identifications are configured. For example, a list corresponding to a second-level category “Youth literature” may be a ranking list of “Youth literature” books. Then, a recommendation word type and an attribute type are configured. For example, the recommendation word type may include Talent recommendation, positive review recommendation, and the like, and the attribute type may include a book attribute, a cosmetic attribute, and the like. Finally, recommended words and attributes that correspond to the listed objects are queried based on the SPU basic data, thereby generating the first page (i.e., an SPU list aggregation page).

In practical applications, a user may enter the first page through a third page (i.e., a list entry) when browsing the list entry. The first page may include a detail display page for a book, a livestreaming page for a mobile phone, and a short video playback page of a computer that is included in an image frame. In a process of displaying a first list on the first page (i.e., the SPU list aggregation page), when a trigger operation for a target listed object on the first list has been received, an object in an object set identified by the target listed object is presented on a second page (i.e., a search result page).

As can be seen, the embodiments of the present disclosure can display listed objects on a list based on an object set obtained by aggregation of aggregation information, thereby enriching a method for displaying a list and meeting a need of a user for a list function.

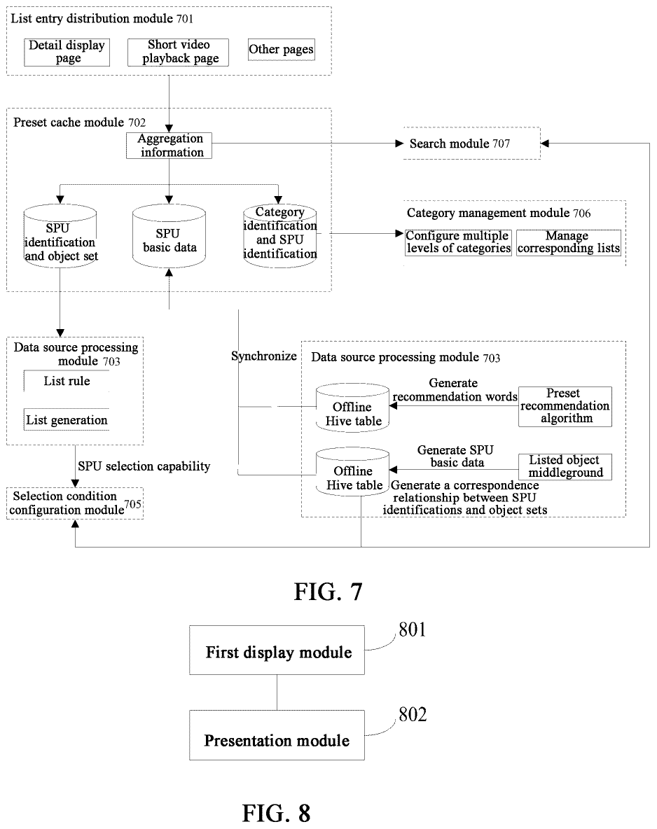

Based on the above method embodiment, the present disclosure further provides a schematic diagram of a list processing system. Specifically, a book list is taken as an example. FIG. 7 is a schematic diagram of a list processing system according to an embodiment of the present disclosure. The list processing system includes a list entry distribution module 701, a preset cache module 702, a data source processing module 703, a list generation module 704, a selection condition configuration module 705, a category management module 706, and a search module 707.

The list entry distribution module 701 is configured to set a display position of a “list entry”. The display position of the “list entry” may be set on a detail display page, a short video playback page, or the like. For example, the “list entry” may be set on a detail display page of a book. Specifically, “The same is selected as a literary novel list” displayed on the detail display page may be set as the “list entry”.

The preset cache module 702 is configured to store a correspondence relationship between SPU identifications and object sets identified by listed objects, a correspondence relationship between category identifications and a plurality of SPU identifications having a sequential relationship, SPU basic data, attribute information of the listed objects, aggregation information of the object sets identified by the listed objects, and the like.

The data source processing module 703 is configured to generate recommendation words for a listed object (i.e., a book) based on a preset recommendation algorithm, and synchronize the SPU basic data generated by a listed object middle ground and the correspondence relationship between the SPU identifications and the object sets identified by the listed objects to the preset cache module 702.

The list generation module 704 is configured to: generate a first list based on the correspondence relationship, stored in the preset cache module 702, between the SPU identifications and the object sets identified by the listed objects and determine the sequential relationship (i.e., a list rule) between the plurality of listed objects presented on the first list.

The selection condition configuration module 705 is configured to filter listed objects that do not comply with the list rule in the process of establishing the correspondence relationship between the SPU identifications and the object sets identified by the listed objects, such as removing children's books that clearly do not belong to a novel type from the first list.

The category management module 706 is configured to: configure a multi-level category structure relationship between a plurality of categories based on the correspondence relationship, stored in the preset cache module 702, between the category identifications and the plurality of SPU identifications having the sequential relationship, and manage lists respectively corresponding to the plurality of categories.

The search module 707 is configured to: obtain an object set corresponding to an SPU identification from the preset cache module 702, determine a search result object based on a search keyword, display an object in the object set on a second page (i.e., a search result page), and display the search result object on the second page.

As can be seen, the list processing system according to this embodiment of the present disclosure can display listed objects on a list based on the object set obtained by aggregation of aggregation information, thereby enriching a method for displaying a list and meeting a need of a user for a list function.

Based on the above method embodiment, the present disclosure further provides a list processing apparatus. FIG. 8 is a schematic structural diagram of a list processing apparatus according to an embodiment of the present disclosure. The apparatus includes:
a first display module 801, configured to display a first list on a first page, wherein a plurality of listed objects having a sequential relationship are presented on the first list, and the listed object is used for identifying an object set obtained by aggregation based on aggregation information; and
a presentation module 802, configured to: in response to a trigger operation for a target listed object on the first list, present, on a second page, an object in an object set identified by the target listed object.

In an optional implementation, the apparatus further includes:
a determining module, configured to: determine, in response to a list presenting trigger operation performed on a third page corresponding to a first object, a list to which the first object belongs as the first list, and obtain the listed objects in the first list.

In an optional implementation, the apparatus further includes:
a second display module, configured to: display the third page in response to a display request for the third page corresponding to the first object, and determine whether the first object belongs to at least one list; and
a third display module, configured to: if it is determined that the first object belongs to at least one list, display, on the third page, ranking information of the first object on a target list among the at least one list.

Correspondingly, the determining module includes:
a first determining submodule, configured to determine, in response to a trigger operation for the ranking information, the target list corresponding to the ranking information as the first list.

In an optional implementation, a plurality of categories are configured on the first page; the plurality of categories have a multi-level category structure relationship; the plurality of categories respectively have corresponding lists; listed objects of the lists belong to the categories corresponding to the lists; and the first display module includes:
a first display submodule, configured to display, in response to a trigger operation for a target category among the plurality of categories, a list corresponding to the target category on the first page.

In an optional implementation, the first display submodule includes:
a first sending submodule, configured to: in response to the trigger operation for the target category among the plurality of categories, send, to a first target service end, a list display request that carries a target category identification corresponding to the target category, wherein the first target service end is configured to obtain, from a preset cache, a plurality of SPU identifications having a sequential relationship and corresponding to the target category identification, and the SPU identifications are used for identifying the listed objects; and
a second display submodule, configured to display, on the first page, the listed objects respectively corresponding to the SPU identifications having the sequential relationship.

In an optional implementation, the listed objects have SPU identifications; the SPU identifications are used for identifying the listed objects; and the presentation module includes:
a second sending submodule, configured to: in response to the trigger operation for the target listed object on the first list, send an SPU identification corresponding to the target listed object and a search keyword to a second target service end, wherein the second target service end is configured to: obtain an object set corresponding to the SPU identification from a preset cache and determine a search result object based on the search keyword; and
a first presentation submodule, configured to present the object in the object set on the second page.

Correspondingly, the method further includes:
a second presentation submodule, configured to present the search result object on the second page.

In an optional implementation, the ranking information display module includes:
a third sending submodule, configured to: in response to the display request, send a page display request for the third page to a third target service end, wherein the third target service end is configured to determine, in a preset cache, whether the first object belongs to any list, and when it is determined that the first object belongs to at least one list, obtain the ranking information of the first object on the target list among the at least one list; and
a third display submodule, configured to display, on the third page, the ranking information of the first object on the target list among the at least one list.

In an optional implementation, the determining module includes:
a fourth sending submodule, configured to: in response to the list presenting trigger operation performed on the third page corresponding to the first object, send, to a fourth target service end, a list presenting request that carries an object identification of the first object, wherein the fourth target service end is configured to: determine, from a preset cache, a target list identification corresponding to the object identification of the first object, and obtain a plurality of SPU identifications having a sequential relationship and corresponding to the target list identification; the SPU identifications are used for identifying the listed objects; and
a first receiving submodule, configured to receive the plurality of SPU identifications having the sequential relationship and corresponding to the object identification of the first object.

Correspondingly, the first display module includes:
a fourth display submodule, configured to display, on the first page, the listed objects respectively identified by the SPU identifications having the sequential relationship.

In an optional implementation, the preset cache is configured to store a list generated based on a preset cycle; and the list includes the SPU identifications having the sequential relationship, a correspondence relationship between a list identification of the list and the category identifications, and a correspondence relationship between the SPU identifications and the object sets.

In the list processing method according to this embodiment of the present disclosure, the method includes: firstly presenting a first list on a first page, wherein a plurality of listed objects having a sequential relationship are presented on the first list, and the listed object is used for identifying an object set obtained by aggregation based on aggregation information; and then when a trigger operation for a target listed object on the first list has been received, presenting, on a second page, an object in an object set identified by the target listed object. As can be seen, the embodiments of the present disclosure can display listed objects on a list based on an object set obtained by aggregation of aggregation information, thereby enriching a method for presenting a list and meeting a need of a user for a list function.

In addition to the above methods and apparatuses, an embodiment of the present disclosure further provides a computer-readable storage medium. The computer-readable storage medium stores an instruction. The instruction, when executed on a terminal device, causes the terminal device to implement the list processing method according to the embodiments of the present disclosure.

An embodiment of the present disclosure further provides a computer program product. The computer program product includes a computer program/instruction, and the computer program/instruction, when executed by a processor, implements the list processing method according to the embodiments of the present disclosure.

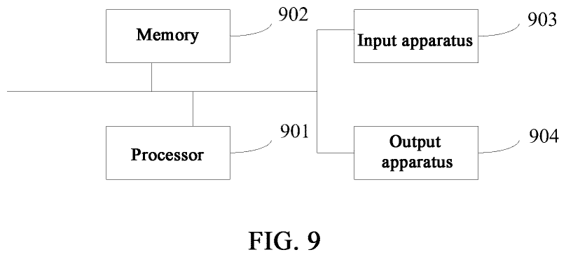

In addition, an embodiment of the present disclosure further provides a list processing device. Referring to FIG. 9, the list processing device may include:
a processor 901, a memory 902, an input apparatus 903, and an output apparatus 904. A quantity of the processor 901 in the list processing device can be one or more. By way of example, FIG. 9 shows one processor. In some embodiments of the present disclosure, the processor 901, the memory 902, the input apparatus 903, and the output apparatus 904 can be connected through a bus or in another way. By way of example, FIG. 9 shows bus connection.

The memory 902 may be configured to store software programs and modules. The processor 901 runs the software programs and modules stored in the memory 902, so as to implement various functional applications and data processing of the list processing device. The memory 902 may mainly include a program storage region and a data storage region. The program storage region may store an operating system, an application program required by at least one function, and the like. In addition, the memory 902 may include a high speed random access memory, and may further include a non-volatile memory, such as at least one magnetic disk storage device, a flash memory, or another volatile solid storage device. The input apparatus 903 may be configured to: receive input numeric or character information and generate signal inputs related to user settings and function control of the list processing device.

Specifically, in this embodiment, the processor 901 may load, according to the following instructions, executable files corresponding to processes of one or more application programs into the memory 902. The processor 901 runs the application programs stored in the memory 902, to implement the various functions of the above list processing device.

It should be noted that in this document, relationship terms such as “first” and “second” are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an ... ” does not exclude the presence of another identical elements in the process, method, article or device that includes the element.

The above only describes the specific implementations of the present disclosure, which enables those skilled in the art to understand or implement the present disclosure. The various modifications to these embodiments will be apparent to those skilled in the art, and the general principles defined herein can be implemented in other embodiments without departing from the spirit or scope of the present disclosure. Thus, the present disclosure is not limited to these embodiments shown herein, but accords with the broadest scope consistent with the principles and novel features disclosed herein.

1. A list processing method, comprising:
displaying a first list on a first page, wherein a plurality of listed objects having a sequential relationship are presented on the first list, and the listed object is used for identifying an object set obtained by aggregation based on aggregation information; and
in response to a trigger operation for a target listed object on the first list, presenting, on a second page, an object in an object set identified by the target listed object.

2. The method according to claim 1, before displaying the first list on the first page, further comprising:
determining, in response to a list presenting trigger operation performed on a third page corresponding to a first object, a list to which the first object belongs as the first list, and obtaining the listed objects in the first list.

3. The method according to claim 2, before determining, in response to the list presenting trigger operation performed on the third page corresponding to the first object, the list to which the first object belongs as the first list, further comprising:
displaying the third page in response to a display request for the third page corresponding to the first object, and determining whether the first object belongs to at least one list; and
in response to determining that the first object belongs to at least one list, displaying, on the third page, ranking information of the first object on a target list among the at least one list,
wherein correspondingly, determining, in response to the list presenting trigger operation performed on the third page corresponding to the first object, the list to which the first object belongs as the first list comprises:
determining, in response to a trigger operation for the ranking information, the target list corresponding to the ranking information as the first list.

4. The method according to claim 1, wherein a plurality of categories are configured on the first page; the plurality of categories have a multi-level category structure relationship; the plurality of categories respectively have corresponding lists; listed objects of the lists belong to the categories corresponding to the lists; and the displaying the first list on the first page comprises:
displaying, in response to a trigger operation for a target category among the plurality of categories, a list corresponding to the target category on the first page.

5. The method according to claim 4, wherein displaying, in response to the trigger operation for the target category among the plurality of categories, the list corresponding to the target category on the first page comprises:
in response to the trigger operation for the target category among the plurality of categories, sending, to a first target service end, a list display request that carries a target category identification corresponding to the target category, wherein the first target service end is configured to obtain, from a preset cache, a plurality of standard product unit (SPU) identifications having a sequential relationship and corresponding to the target category identification, and the SPU identifications are used for identifying the listed objects; and
displaying, on the first page, the listed objects respectively corresponding to the SPU identifications having the sequential relationship.

6. The method according to claim 1, wherein the listed objects have SPU identifications; the SPU identifications are used for identifying the listed objects; and in response to the trigger operation for the target listed object on the first list, presenting, on the second page, the object in the object set identified by the target listed object comprises:
in response to the trigger operation for the target listed object on the first list, sending an SPU identification corresponding to the target listed object and a search keyword to a second target service end, wherein the second target service end is configured to: obtain an object set corresponding to the SPU identification from a preset cache and determine a search result object based on the search keyword; and
presenting the object in the object set on the second page;
correspondingly, the method further comprises:
displaying the search result object on the second page.

7. The method according to claim 3, wherein in response to the display request, in response to determining that the first object belongs to at least one list, displaying, on the third page, ranking information of the first object on the target list among the at least one list comprises:
in response to the display request, sending a page display request for the third page to a third target service end, wherein the third target service end is configured to: determine, in a preset cache, whether the first object belongs to any list, and in response to determining that the first object belongs to at least one list, obtain the ranking information of the first object on the target list among the at least one list; and
displaying, on the third page, the ranking information of the first object on the target list among the at least one list.

8. The method according to claim 2, wherein determining, in response to the list presenting trigger operation performed on the third page corresponding to the first object, the list to which the first object belongs as the first list, and obtaining the listed objects in the first list comprises:
in response to the list presenting trigger operation performed on the third page corresponding to the first object, sending, to a fourth target service end, a list presenting request that carries an object identification of the first object, wherein the fourth target service end is configured to: determine, from a preset cache, a target list identification corresponding to the object identification of the first object, and obtain a plurality of SPU identifications having a sequential relationship and corresponding to the target list identification; the SPU identifications are used for identifying the listed objects; and
receiving the plurality of SPU identifications having the sequential relationship and corresponding to the object identification of the first object; and
correspondingly, displaying the first list on the first page comprises:
displaying, on the first page, the listed objects respectively identified by the SPU identifications having the sequential relationship.

9. The method according to claim 5, wherein the preset cache is configured to store a list generated based on a preset cycle; and the list comprises the SPU identifications having the sequential relationship, a correspondence relationship between a list identification of the list and category identifications, and a correspondence relationship between the SPU identifications and the object sets.

10. (canceled)

11. A non-transitory computer-readable storage medium, having instructions stored therein, wherein the instructions, when executed on a device, cause the device to:
display a first list on a first page, wherein a plurality of listed objects having a sequential relationship are presented on the first list, and the listed object is used for identifying an object set obtained by aggregation based on aggregation information; and
in response to a trigger operation for a target listed object on the first list, present, on a second page, an object in an object set identified by the target listed object.

12. A list processing device, comprising a memory, a processor, and a computer program stored on the memory and executable on the processor, wherein the processor, when executing the computer program, causing the device to:
display a first list on a first page, wherein a plurality of listed objects having a sequential relationship are presented on the first list, and the listed object is used for identifying an object set obtained by aggregation based on aggregation information; and
in response to a trigger operation for a target listed object on the first list, present, on a second page, an object in an object set identified by the target listed object.

13. The medium according to claim 11, before displaying the first list on the first page, the medium further comprises instructions causing the device to:
determine, in response to a list presenting trigger operation performed on a third page corresponding to a first object, a list to which the first object belongs as the first list, and obtaining the listed objects in the first list.

14. The medium according to claim 13, before determining, in response to the list presenting trigger operation performed on the third page corresponding to the first object, the list to which the first object belongs as the first list, the medium further comprises instructions causing the device to:
display the third page in response to a display request for the third page corresponding to the first object, and determining whether the first object belongs to at least one list; and
in response to determining that the first object belongs to at least one list, display, on the third page, ranking information of the first object on a target list among the at least one list,
wherein the instructions causing the device to determine, in response to the list presenting trigger operation performed on the third page corresponding to the first object, the list to which the first object belongs as the first list comprises instructions causing the device to:
determine, in response to a trigger operation for the ranking information, the target list corresponding to the ranking information as the first list.

15. The medium according to claim 11, wherein a plurality of categories are configured on the first page; the plurality of categories have a multi-level category structure relationship; the plurality of categories respectively have corresponding lists; listed objects of the lists belong to the categories corresponding to the lists; and the instructions causing the device to display the first list on the first page comprises instructions causing the device to:
display, in response to a trigger operation for a target category among the plurality of categories, a list corresponding to the target category on the first page.

16. The medium according to claim 15, wherein the instructions causing the device to display, in response to the trigger operation for the target category among the plurality of categories, the list corresponding to the target category on the first page comprises the instructions causing the device to:
in response to the trigger operation for the target category among the plurality of categories, send, to a first target service end, a list display request that carries a target category identification corresponding to the target category, wherein the first target service end is configured to obtain, from a preset cache, a plurality of standard product unit (SPU) identifications having a sequential relationship and corresponding to the target category identification, and the SPU identifications are used for identifying the listed objects; and
display, on the first page, the listed objects respectively corresponding to the SPU identifications having the sequential relationship.

17. The medium according to claim 11, wherein the listed objects have SPU identifications; the SPU identifications are used for identifying the listed objects; and instructions causing the device to in response to the trigger operation for the target listed object on the first list, present, on the second page, the object in the object set identified by the target listed object comprise instructions causing the device to:
in response to the trigger operation for the target listed object on the first list, send an SPU identification corresponding to the target listed object and a search keyword to a second target service end, wherein the second target service end is configured to: obtain an object set corresponding to the SPU identification from a preset cache and determine a search result object based on the search keyword; and
present the object in the object set on the second page;
the device is further caused to:
display the search result object on the second page.

18. The method according to claim 14, wherein the instructions causing the device to, in response to the display request, in response to determining that the first object belongs to at least one list, display, on the third page, ranking information of the first object on the target list among the at least one list comprises instructions causing the device to:
in response to the display request, send a page display request for the third page to a third target service end, wherein the third target service end is configured to: determine, in a preset cache, whether the first object belongs to any list, and in response to determining that the first object belongs to at least one list, obtain the ranking information of the first object on the target list among the at least one list; and
display, on the third page, the ranking information of the first object on the target list among the at least one list.

19. The medium according to claim 13, wherein the instructions causing the device to determine, in response to the list presenting trigger operation performed on the third page corresponding to the first object, the list to which the first object belongs as the first list, and obtain the listed objects in the first list comprise instructions causing the device to:
in response to the list presenting trigger operation performed on the third page corresponding to the first object, send, to a fourth target service end, a list presenting request that carries an object identification of the first object, wherein the fourth target service end is configured to: determine, from a preset cache, a target list identification corresponding to the object identification of the first object, and obtain a plurality of SPU identifications having a sequential relationship and corresponding to the target list identification; the SPU identifications are used for identifying the listed objects; and
receive the plurality of SPU identifications having the sequential relationship and corresponding to the object identification of the first object; and
the instructions causing the device to display the first list on the first page comprise instructions causing the device to:
display, on the first page, the listed objects respectively identified by the SPU identifications having the sequential relationship.

20. The medium according to claim 16, wherein the preset cache is configured to store a list generated based on a preset cycle; and the list comprises the SPU identifications having the sequential relationship, a correspondence relationship between a list identification of the list and category identifications, and a correspondence relationship between the SPU identifications and the object sets.

21. The device according to claim 12, before displaying the first list on the first page, the device is further caused to:
determine, in response to a list presenting trigger operation performed on a third page corresponding to a first object, a list to which the first object belongs as the first list, and obtaining the listed objects in the first list.
